(19) United States
(12) Patent Application Publication
(10) Pub. No.: US 2026/0346415 A1
(43) Pub. Date: Nov. 5, 2026

(54) COIL NAILER

(71) Applicant: JINHUA XINGYUAN HARDWARE PRODUCTS CO., LTD., Jinhua (CN)

(72) Inventor: Weixing YANG, Jinhua (CN)

(73) Assignee: JINHUA XINGYUAN HARDWARE PRODUCTS CO., LTD., Jinhua (CN)

(21) Appl. No.: 18/995,939

(22) PCT Filed: Aug. 28, 2023
(86) PCT No.: PCT/CN2023/115241

§ 371 Date: Jan. 17, 2025

(30) Foreign Application Priority Data
Sep. 22, 2022 (CN) 202211160166.0

(51) Int. Cl. B25C 1/00

(52) U.S. Cl. CPC B25C 1/003

(57) ABSTRACT

A coil nailer includes a nailing guide structure fixedly connected to a nailer body and used for guiding nailing, a nail storage structure capable of storing coil nails, and a nail feeding mechanism fixedly connected between the nailing guide structure and the nail storage structure. The nail feeding mechanism includes a nail conveying plate used for guiding the coil nails and limiting a moving direction of the coil nails, one side of the nail conveying plate is provided with a pushing structure for pushing the coil nails to the nailing guide structure, and two sides of the pushing structure in the same direction are separately provided with a non-return assembly for preventing the coil nails from moving back to the nail storage structure; and a fastening structure capable of pressing one end of the nail storage structure is provided above the nail feeding mechanism.

### CROSS REFERENCE TO THE RELATED APPLICATIONS

This application is the national phase entry of International Application No. PCT/CN2023/115241, filed on Aug. 28, 2023, which is based upon and claims priority to Chinese Patent Application No. 202211160166.0, filed on Sep. 22, 2022, the entire contents of which are incorporated herein by reference.

### TECHNICAL FIELD

The present disclosure belongs to the technical field of coil nailers, and particularly relates to a coil nailer.

### BACKGROUND

In the prior art, coil nails placed in a coil nailer all are formed by winding metal wires or metal clamping sheets. There are separation distances among the nails. Therefore, a coil nailer capable of using the coil nails is specially equipped. CN203650447U discloses a nail feeding mechanism of a pneumatic coil nailer, including a nailer head, a trajectory provided in the nailer head, a movable cover plate hinged to the nailer head, coil nail boxes, and a nail placing rack provided between the coil nail boxes. A five-tooth nail feeding claw is provided at a junction between the trajectory and the nail-placing rack. A nail-stopping block matching with the five-tooth nail feeding claw is provided on the movable cover plate. A position-correcting block matching the trajectory is provided on the movable cover plate. A pressure spring is provided between the position-correcting block and the movable cover plate.

This coil nailer can only be matched with coil nails with separation distances for use and cannot be compatible with coil nails attached in rows by means of a flexible belt (the coil nails in rows are attached tightly). When the coil nailer performs nailing, since the nails are connected in rows through a clamping sheet or a metal wire, the clamping sheet or metal wire left on the nails will be worn or left in a nailing channel once the nails are separated, resulting in a nail jamming phenomenon during nailing in the later period. Once the coil nailer performs an operation on an article, an iron wire left phenomenon easily happens on the surface of a workpiece, which results in the article being scratched. For example, if there is an iron wire left on the surface of a tray loaded with a chemical product, a liquid will be leaked from a container, which affects the pass percentage of the products.

### SUMMARY

### Technical Problems

An existing coil nailer is narrow in its range of application, and can only match with coil nails with separation distances. When the nails are separated, a metal clamping sheet and a metal wire are easily worn or left in the nailing channel, which easily induces nail jamming in the later period. In addition, during the operation of a conventional coil nailer, an iron wire left phenomenon easily happens, which results in that an article is scratched, thereby affecting the pass percentage of the products.

### Technical Solutions

To aim at the above problems in the coil nailer, a coil nailer is invented. The coil nailer can push nails attached in rows by means of a flexible belt into a nailing guide structure steadily, which avoids a nail jamming phenomenon during nailing and further improves the pass percentage of the products.

The above technical problems manifested in the present disclosure are resolved by the following technical solution: A coil nailer, including a nailing guide structure fixedly connected to a nailer body and used for guiding nailing, and a nail storage structure capable of storing coil nails, and further including a nail feeding mechanism fixedly connected between the nailing guide structure and the nail storage structure, where the nail feeding mechanism includes a nail conveying plate used for guiding the coil nails and limiting the moving direction of the coil nails, one side of the nail conveying plate is provided with a pushing structure for pushing the coil nails to the nailing guide structure, and two sides of the pushing structure in the same direction are separately provided with a non-return assembly for preventing the coil nails from moving back to the nail storage structure; and a fastening structure capable of pressing one end of the nail storage structure is provided above the nail feeding mechanism, and the fastening structure is further provided with a shifting rod capable of shifting the pushing structure and the non-return assemblies away from the nails.

Preferably, the pushing structure includes a pushing member and a moving member I enclosing the pushing member, and at least two pushing members are provided; a first groove is formed below the moving member I, the first groove is in a sliding fit with a first boss with a slope in a linking member, where the linking member semi-encloses the pushing member and the moving member I; perpendicular to the nail conveying plate, one end of the linking member passes through a brake for connection, and the brake drives the pushing structure to reciprocate.

In the above settings, when the coil nails are pushed, the pushing member in this case is higher than the plane of the nail conveying plate to press the coil nails to the cover plate, and under the action of the brake, the coil nails are pushed to move toward the nailing guide structure, where the brake is a one-way air cylinder. When the pushing structure moves toward the nail storage structure, the pushing member in this case unloosens compressing the coil nails as the moving member I slides toward the lowest position of the slope of the first boss, to recirculate to realize stable pushing.

Preferably, the non-return assembly includes a non-return member and a moving member II enclosing the non-return member, and a second groove is formed below the moving member II; below the corresponding moving member II, a second boss in sliding fit with the second groove is further provided on the nail conveying plate, and there is an inclined slope between the second boss and the horizontal plane.

In the above settings, when the pushing structure does not work and unloosens the compressing of the nails, in order to prevent looseness, an elastic sheet is provided in a circumferential direction of the coil nails when the coil nails in the nail storage structure are loosened gradually. Therefore, a force of pulling back the coil nails is formed, so that the nails recoil toward the nail storage structure without the non-return assembly. In the present disclosure, a section of coil nails will be left when the coil nails are used to the end, the left coil nails are the length from being separated from the pushing structure to be compressed to the nailing guide structure, and in this case, the non-return assembly provided close to the nailing guide structure plays a role of compressing the left coil nails, which contributes to a seamless connection between newly loaded coil nails and the coil nails left in the previous period. Even if the last nail is left in the previous period, the nail can also be steadily pushed into the nailing guide structure effectively.

Preferably, perpendicular to a moving direction of the coil nails, waist-shaped holes are respectively formed on both sides of the moving member I and the moving member II, and a protruding portion I is provided on one side of each of the moving member I and the moving member II toward the shifting rod.

In the above settings, the protruding portion I provided avoids an interference phenomenon of the shifting rod, but also facilitates the shifting rod to push the moving member I and the moving member II rapidly to move toward the nailing guide structure. A first groove and a second groove respectively provided below the moving member I and the moving member II can be provided in a T shape or a V shape to improve the stability of sliding fit with the first boss and the second boss. In the moving process of the moving member I and the moving member II, the moving pushing member and the non-return member that are not supported by the first boss and the second boss move downward along the waist-shaped holes due to their own weights to unloosen the compressing of the coil nails.

Preferably, a cover plate capable of being opened or closed is provided above the nail conveying plate, one end of the cover plate is hinged with the nailing guide structure, and the other end of the cover plate extends toward the nail storage structure; and in the moving direction of the coil nails, a plurality of notches for avoiding nail caps are further provided on two planes where the nail conveying plate and the cover plate are attached each other, and the plurality of notches are provided in an equally divided manner.

In the above settings, when the fastening member is manually pushed to be close to the protruding portion II, in this case, the cover plate is disconnected from the nail conveying plate and meanwhile, the fastening structure also loosens the compressing of the nail storage structure. Therefore, the arrangement of combining the cover plate with the fastening structure facilitates loading of the coil nails and further contributes to maintaining and repairing the present disclosure in daily time; the notches provided in the cover plate, on the one hand, avoid the nail cap portions of the nails, and on the other hand, the plurality of notches are capable of being compatible with nails with different lengths. The used nails can be T-shaped or F-shaped, so that the universality of the present disclosure is improved.

Preferably, in a direction close to the nail storage structure, a protruding portion II is provided at one end of the cover plate, and a positioning portion is further provided relative to the protruding portion II; the fastening structure includes a fastening member, and the fastening member slides in the positioning portion; perpendicular to the upper side of the cover plate, the protruding portion II is in a threaded fit with a screw, and an elastic member is sleeved on the screw and is provided between the protruding portion II and the fastening member; and the fastening member is further provided with an extension portion extending toward the shifting rod, and a floating member in sliding fit with the nail conveying plate is further provided below the fastening member.

The shifting rod in the above settings is provided with a protruding portion III for pushing the moving member I and the moving member II. Both ends of the shifting rod are provided with waist-shaped holes and are in a sliding fit with dowels embedded into the nail conveying plate. Therefore, when the coil nails are needed to be loaded in the present disclosure, in the process of manually pushing the fastening member to move toward the protruding portion II, the shifting rod, the moving member I, and the moving member II all move toward the nailing guide structure to promote the pushing member and the non-return member to be away from the coil nails to reserve a position for loading the coil nails. When the floating member is separated from the pressing of the fastening member, the floating member stretches out toward the direction of the cover plate through resetting of the spring, and in this case, the shifting rod is also separated from the pushing of the extension portion. Then, the shifting rod, under the action of a tension spring, moves toward the direction of the nail storage structure. The end abuts against one side of the floating member to limit continuous movement of the shifting rod to reserve the position at which the fastening member is locked back, thereby achieving an automatic lock-back function.

Preferably, a guide bar parallel to the nail conveying plate is further provided between the nailing guide structure and the nail storage structure.

A notch is formed in the guide bar in the above settings, a plane of the notch and the nail conveying plate are in the same plane, and the guide bar assists the nail conveying plate and limits the coil nails in multiple directions, to guarantee that the pushed nails are perpendicular to the moving direction of the coil nails. Therefore, the nail jamming phenomenon during nailing can be avoided.

Preferably, the nail conveying plate is further provided with a nail limiting groove capable of sleeving a U-shaped nail on the nail conveying plate to move.

The U-shaped nails in the above settings are also provided in rows by means of a flexible belt and can be coiled. On the one hand, the nail storage structure where the coiled U-shaped nails are placed is consistent with the nail storage structure where T-shaped and F-shaped nails are placed. Therefore, the frequency of replacing the nail storage structure can be reduced. On the other hand, the nail feeding mechanism can effectively push the T-shaped, F-shaped, and U-shaped nails into the nailing guide structure to accomplish the nailing operation, so that the universality of the present disclosure is improved.

Preferably, the fastening structure further includes a pulling member, the pulling member is fixedly connected to one end of a rotating shaft, and the other end of the rotating shaft passing through the nail conveying plate to extend toward the brake is fixedly connected to a turning member.

In the above settings, when the pulling member is manually pulled to rotate toward the nail storage structure, in this case, the turning member fixedly connected to the other end of the rotating shaft also rotates toward the direction of the nailing guide structure. The turning member pushes the shifting rod to move in the rotating process, and together with the shifting rod, also pushes the moving member I and the moving member II to move to promote the pushing member and the non-return member to loosen the compressing of the coil nails. The above linked structure skillfully resolves the problem of manually loading the nails rapidly.

Preferably, a signal rod extending toward the coil nails is provided between the pushing structure and the brake.

In the above settings, the provided signal rod is mounted on one side of the brake and an elastic member is also mounted therebetween. One end of the signal rod vertically extending is close to the nailing guide structure. One end extending toward the cover plate is also provided in the middle of the signal rod. When there are no coil nails leaning against the end of the signal rod to stretch out, under the action of the elastic member, one end of the signal rod clings to the nailing guide structure to limit the movement of a safety switch, so that the present disclosure cannot be used normally, and moreover, it is also a signal that prompts a user that there are no nails.

### Beneficial Effects

When it is expected to load the coil nails in the present disclosure, the fastening structure is manually pushed to move, and the shifting rod linked with the fastening structure also pushes the pushing structure and the non-return assembly to move toward the direction of the nailing guide structure to promote the pushing structure and the non-return assembly to be away from the coil nails to clear the position where the nails are loaded. So the coil nails attached in rows by means of the flexible belt can be manually loaded on the nail conveying plate smoothly, and then the pushing structure and the non-return assembly compress the coil nails. After the nails are loaded, under the action of the brake, the pushing structure pushes the compressed coil nails in a reciprocating manner. The pushing structure moves toward the nailing guide structure to compress the coil nails. In addition, the pushing structure moves toward the nail storage structure to loosen the compressing of the coil nails. In such circulation, the coil nails are steadily pushed to the nailing channel automatically, and in the pushing process, the nail jamming phenomenon hardly happens. The coil nails used in the present disclosure are attached by means of the flexible belt, and the two are combined to effectively avoid the nail jamming phenomenon during nailing. For example, even if the flexible belt is still left on the nails, the nailing channel is no longer damaged, and moreover, the article can also be effectively prevented from being scratched.

### BRIEF DESCRIPTION OF THE DRAWINGS

FIG. 1 is an overall schematic structural diagram of an embodiment 1 of the present disclosure;

FIG. 2 is an exploded view of a nail feeding mechanism in the embodiment 1 of the present disclosure;

FIG. 3 is a partial section view of the nail feeding mechanism in the embodiment 1 of the present disclosure;

FIG. 4 is a schematic diagram where a cover plate of the nail feeding mechanism is opened to load nails in the embodiment 1 of the present disclosure;

FIG. 5 is a partial schematic diagram of a pushing structure and a non-return assembly in the embodiment 1 of the present disclosure;

FIG. 6 is a partial schematic diagram of a pushing structure and a non-return assembly in the embodiment 1 of the present disclosure;

FIG. 7 is a schematic diagram of a linking member in the embodiment 1 of the present disclosure;

FIG. 8 is a schematic diagram where coil nails are oppositely pushed in the embodiment 1 of the present disclosure;

FIG. 9 is an exploded view of a nail feeding mechanism in an embodiment 2 of the present disclosure;

FIG. 10 is a local section view of the nail feeding mechanism in the embodiment 2 of the present disclosure;

FIG. 11 is a schematic diagram of a linking member in the embodiment 2 of the present disclosure; and

FIG. 12 a schematic diagram where nails are oppositely pushed in the embodiment 2 of the present disclosure.

### NUMERALS IN THE FIGURES

1. nailer body, 2, nailing guide structure; 3, nail feeding mechanism; 31, nail conveying plate; 311, second boss; 312, notch; 313, nail limiting groove; 32, pushing structure; 321, pushing member; 322, moving member I; 3221, first groove; 3222, waist-shaped hole; 323, linking member; 3231, first boss; 33, non-return assembly; 331, non-return member; 322, moving member II; 3321, second groove; 3322, protruding portion I; 34, cover plate; 341, protruding portion II; 342, positioning portion; 35, fastening structure; 351, shifting rod; 352, fastening member; 3521, extension portion; 353, elastic member; 354, pulling member; 355, rotating shaft; 356, turning member; 36, brake; 37, floating member; 38, guide bar; 39, signal rod; 4, nail storage structure.

### DETAILED DESCRIPTION OF THE EMBODIMENTS

### Embodiment I

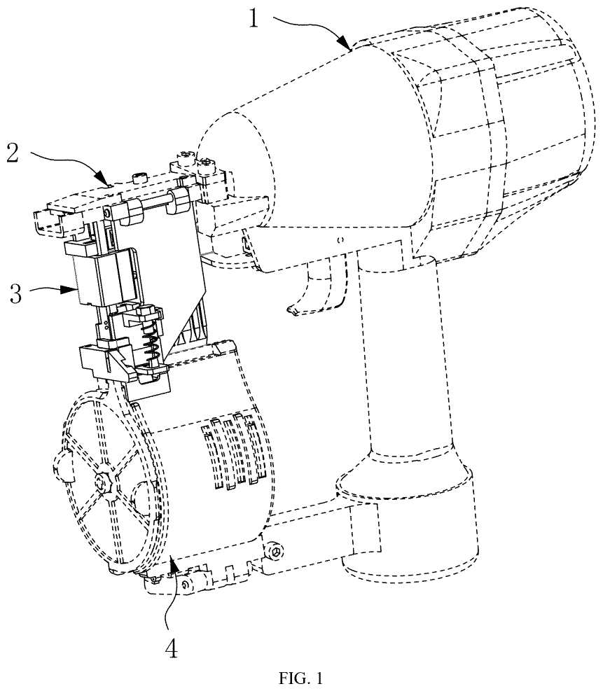

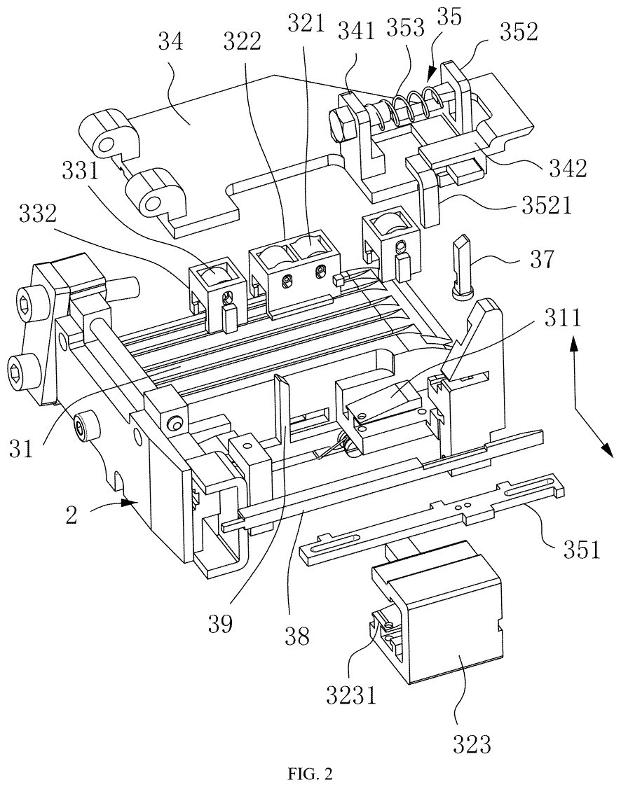

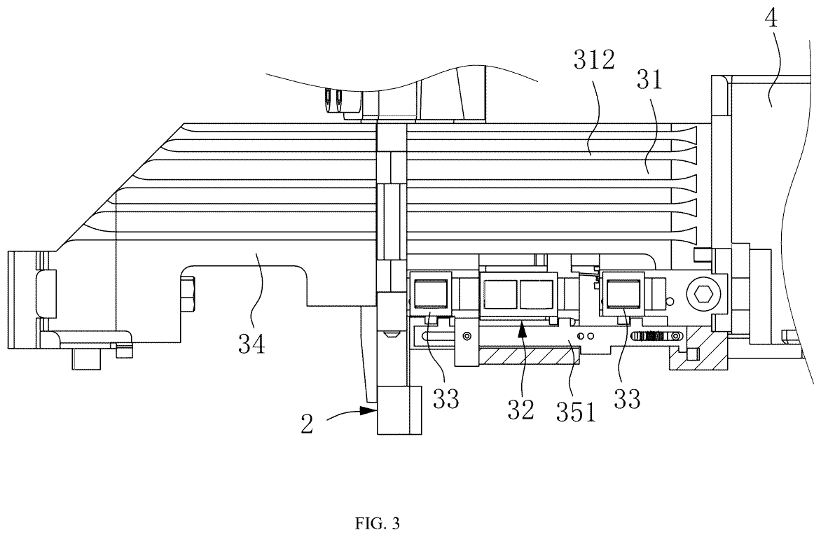

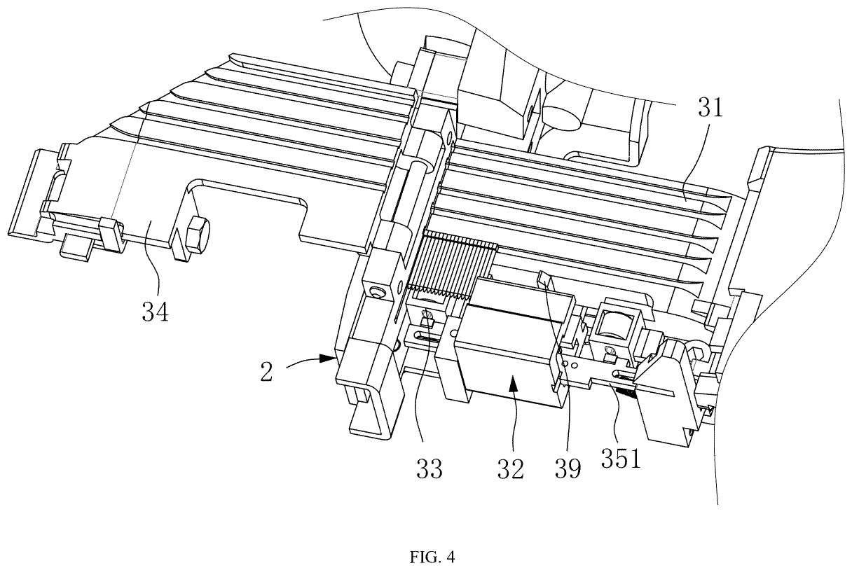

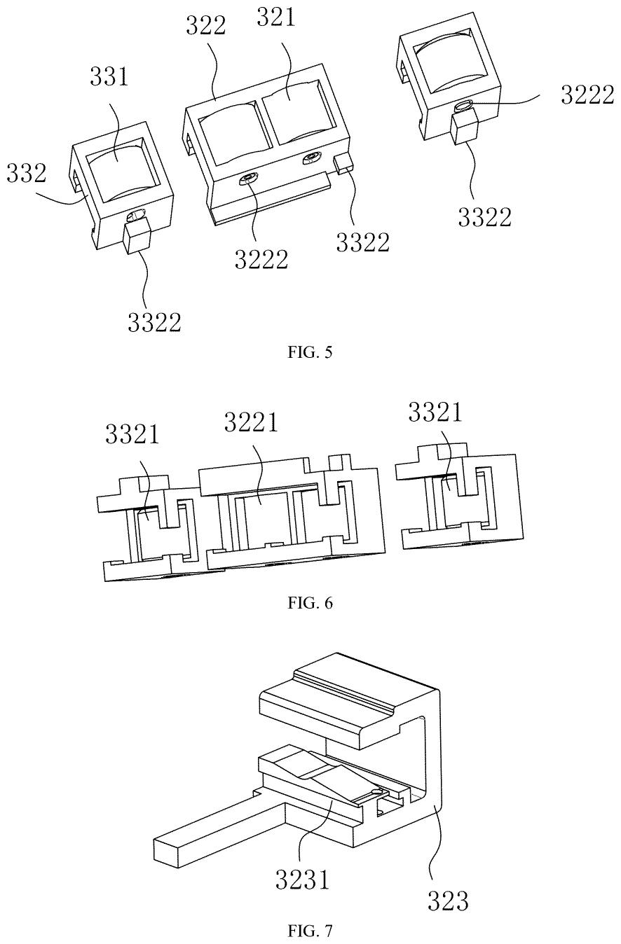

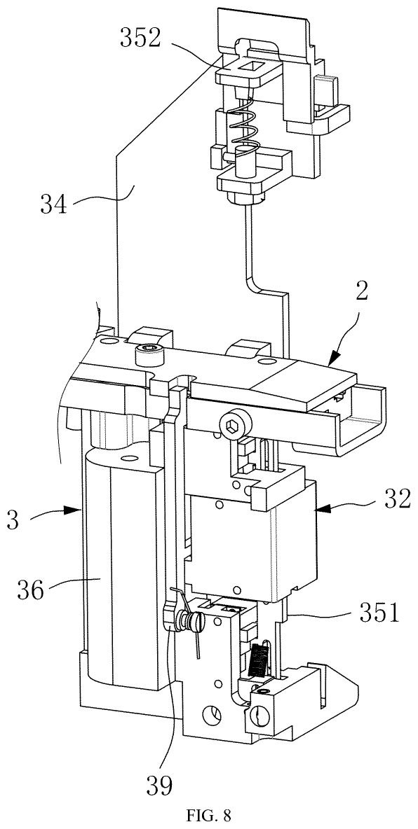

As shown in FIGS. 1-8, a coil nailer, including a nail feeding mechanism 3 fixedly connected between a nailing guide structure 2 and a nail storage structure 4, where the nail feeding mechanism 3 includes a nail conveying plate 31 used for guiding the coil nails and limiting a moving direction of the coil nails, one side of the nail conveying plate 31 is provided with a pushing structure 32 for pushing the coil nails to the nailing guide structure 2, and two sides of the pushing structure 32 in the same direction are separately provided with a non-return assembly 33 for preventing the coil nails from moving back to the nail storage structure 4; and a fastening structure 35 capable of pressing one end of the nail storage structure 4 is provided above the nail feeding mechanism 3, and the fastening structure is further provided with a shifting rod 351 capable of shifting the pushing structure 32 and the non-return assemblies 33 away from the nails.

The pushing structure 32 includes a pushing member 321 and a moving member I 322 enclosing the pushing member 321, and at least two pushing members 321 are provided; a first groove 3221 is formed below the moving member I 322, the first groove 3221 is in a sliding fit with a first boss 3231 with a slope in a linking member 323, where the linking member 323 semi-encloses the pushing member 321 and the moving member I 322; perpendicular to the nail conveying plate 31, one end of the linking member 323 passes through a brake 36 for connection, and the brake 36 drives the pushing structure 32 to reciprocate. In the embodiment, when the coil nails are pushed, the pushing member 321 in this case is higher than the plane of the nail conveying plate 31 to press the coil nails to the cover plate 34, and under the action of the brake 36, the coil nails are pushed to move toward the nailing guide structure 2. When the pushing structure 32 moves toward the nail storage structure 4, the pushing member 321 in this case unloosens compressing of the coil nails as the moving member I 322 slides toward the lowest position of the slope of the first boss 3231, to recirculate to realize stable pushing.

The non-return assembly 33 includes a non-return member 331 and a moving member II 332 enclosing the non-return member 331, and a second groove 3321 is formed below the moving member II 332; below the corresponding moving member II 332, a second boss 311 in sliding fit with the second groove 3321 is further provided on the nail conveying plate 31, and there is an inclined slope between the second boss 311 and the horizontal plane. In the embodiment, when the pushing structure 32 does not work and unloosens the compressing of the nails, in order to prevent looseness, an elastic sheet is provided in a circumferential direction of the coil nails when the coil nails in the nail storage structure 4 are lessened gradually. Therefore, a force of pulling back the coil nails is formed, so that the nails recoil toward the nail storage structure 4 without the non-return assembly 33. In the present disclosure, a section of coil nails will be left when the coil nails are used to the end, the left coil nails are the length from being separated from the pushing structure 32 to be compressed to the nailing guide structure 2, and in this case, the non-return assembly 33 provided close to the nailing guide structure 2 plays a role of compressing the left coil nails, which contributes to seamless connection between newly loaded coil nails and the coil nails left in the previous period. Even if the last nail is left in the previous period, the nail can also be steadily pushed into the nailing guide structure 2 effectively. The present disclosure further avoids the nail jamming phenomenon while steadily pushing the coil nails.

Perpendicular to a moving direction of the coil nails, waist-shaped holes 3222 are respectively formed on both sides of the moving member I 322 and the moving member II 332, and a protruding portion I 3322 is provided on one side of each of the moving member I 322 and the moving member II 332 toward the shifting rod 351. The provided protruding portion I 3322 not only avoids an interference phenomenon of the shifting rod 351, but also facilitates the shifting rod 651 to push the moving member I 322 and the moving member II 332 rapidly to move toward the nailing guide structure 2. A first groove 3221 and a second groove 3321 respectively provided below the moving member I 322 and the moving member II 332 can be provided in a T shape or a V shape to improve the stability of the sliding fit with the first boss 3231 and the second boss 311. In the moving process of the moving member I 322 and the moving member II 332, since the moving pushing member 321 and the non-return member 331 that are not supported by the first boss 3231 and the second boss 311 move downward along the waist-shaped holes 3222 due to their own weights to unloosen the compressing of the coil nails.

A cover plate 34 capable of being opened or closed is provided above the nail conveying plate 31, one end of the cover plate 34 is hinged with the nailing guide structure 2, and the other end of the cover plate 34 extends toward the nail storage structure 4; and in the moving direction of the coil nails, a plurality of notches 312 for avoiding nail caps are further provided on two planes where the nail conveying plate 31 and the cover plate 34 are attached to each other, and the plurality of notches 312 are provided in an equally divided manner. In the embodiment, when the fastening member 352 is manually pushed to be close to the protruding portion II 341, in this case, the cover plate 34 is disconnected with the nail conveying plate 31 and meanwhile, the fastening structure 35 also loosens the compression of the nail storage structure 4. Therefore, the arrangement of combining the cover plate 34 with the fastening structure 35 facilitates loading of the coil nails and further contributes to maintaining and repairing the present disclosure in daily time; the notches 312 provided in the cover plate 34, on the one hand, avoid the nail cap portions of the nails, and on the other hand, the plurality of notches 312 are capable of being compatible with nails with different lengths. The used nails can be T-shaped or F-shaped, so that the universality of the present disclosure is improved.

In a direction close to the nail storage structure 4, a protruding portion II 341 is provided at one end of the cover plate 34, and a positioning portion 342 is further provided relative to the protruding portion II 341; the fastening structure 35 includes a fastening member 352, and the fastening member 352 slides in the positioning portion 342; perpendicular to the upper side of the cover plate 34, the protruding portion II 341 is in a threaded fit with a screw, and an elastic member 353 is sleeved on the screw and is provided between the protruding portion II 341 and the fastening member 352; and the fastening member 352 is further provided with an extension portion 3521 extending toward the shifting rod 351, and a floating member 37 in a sliding fit with the nail conveying plate 31 is further provided below the fastening member 352. In the embodiment, the shifting rod 351 is provided with a protruding portion III for pushing the moving member I 322 and the moving member II 332. Both ends of the shifting rod 351 are provided with the waist-shaped holes and are in a sliding fit with dowels embedded into the nail conveying plate 31. Therefore, when the coil nails are needed to be loaded in the present disclosure, in the process of manually pushing the fastening member 352 to move toward the protruding portion II 341, the shifting rod 351, the moving member I 322, and the moving member II 332 all move toward the nailing guide structure 2 to promote the pushing member 321 and the non-return member 331 to be away from the coil nails to reserve a position for loading the coil nails. When the floating member 37 is separated from the pressing of the fastening member 352, the floating member 37 stretches out toward the direction of the cover plate 34 through resetting of the spring, and in this case, the shifting rod 351 is also separated from pushing of the extension portion 3521. Then, the shifting rod 351, under the action of a tension spring, moves toward the direction of the nail storage structure 4. The end abuts against one side of the floating member 37 to limit continuous movement of the shifting rod 351 to reserve the position at which the fastening member 352 is locked back, thereby achieving an automatic lock-back function.

A guide bar 38 parallel to the nail conveying plate 31 is further provided between the nailing guide structure 2 and the nail storage structure 4. In the embodiment, a notch is formed in the guide bar 38, a plane of the notch and the nail conveying plate 31 are in the same plane, and the guide bar 38 assists the nail conveying plate 31 and limits the coil nails in multiple directions, to guarantee that the pushed nails are perpendicular to the moving direction of the coil nails. Therefore, the nail jamming phenomenon during nailing can be avoided.

A signal rod 39 extending toward the coil nails is provided between the pushing structure 32 and the brake 36. In the embodiment, the provided signal rod 39 is mounted on one side of the brake 36 and an elastic member is also mounted therebetween. One end of the signal rod 39 vertically extending is close to the nailing guide structure 2. One end extending toward the cover plate 34 is also provided in the middle of the signal rod 39. When there are no coil nails leaning against the end of the signal rod 39 to stretch out, under the action of the elastic member, one end of the signal rod 39 clings to the nailing guide structure 2 to limit the movement of a safety switch, so that the present disclosure cannot be used normally, and moreover, it is also a signal that prompts a user that there are no nails.

### Usage Mode

Prior to use of the present disclosure, first, the cover plate 34 is opened to load the coil nails in the nail storage structure 4, and in this case, the fastening structure 35 is manually pushed to move toward the direction opposite to the nail storage structure 4. Moreover, the shifting rod 351 linked with the fastening structure 35 also pushes the pushing structure 32 and the non-return assembly 33 to move toward the direction where the cover plate 34 is opened to promote the pushing structure 32 and the non-return assembly 33 to be lower than the plane of the nail conveying plate 31 where the coil nails are placed. Therefore, the coil nails can be rapidly loaded in the guide bar 38 and the notches 312 formed in the nail conveying plate 31 to limit the coil nails. After the nails are loaded, the cover plate is closed, the pushing structure 32 and the non-return assembly 33 compress the coil nails, and under the action of the brake, the pushing structure 32 reciprocates. In such reciprocation, the coil nails are steadily pushed into the nailing channel automatically. The pushing structure 32 feeds the coil nails at a distance greater than one nail. Therefore, after the nails are fed, the nails are still held, and the first nail in the nailing channel leans against the plane of the cover plate all the way, so that the nail is parallel to the nailing channel, and the nail jamming phenomenon is effectively avoided in the nailing process.

### Embodiment 2

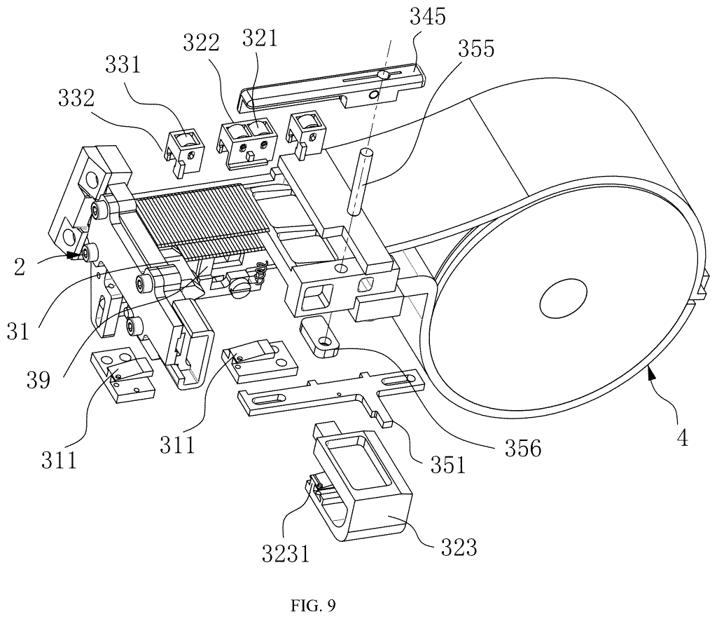

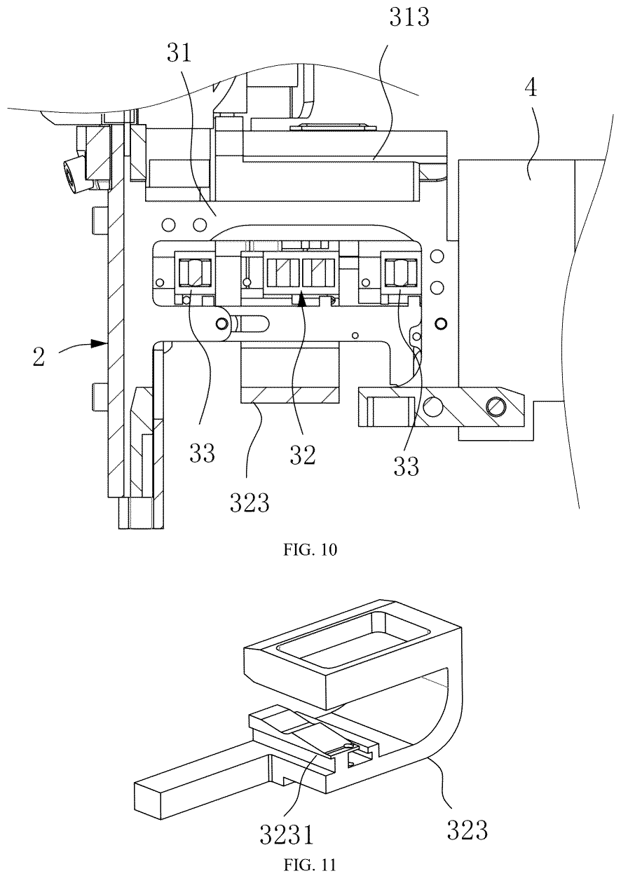

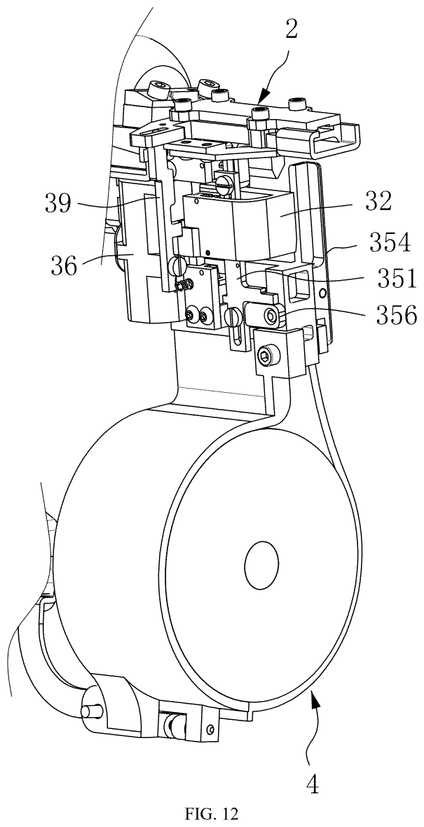

As shown in FIGS. 9-12, the difference between the embodiment and the embodiment 1 lies in that the nail conveying plates for guiding and limiting the nails are inconsistent, and the ways of compressing the nail box cover by the fastening structure are also inconsistent.

The nail conveying plate 31 is further provided with a nail limiting groove 313 capable of sleeving a U-shaped nail on the nail conveying plate 31 to move. In the embodiment, the U-shaped nails are also provided in rows by means of a flexible belt and can be coiled. On the one hand, the nail storage structure 4 where the coiled U-shaped nails are placed is consistent with the nail storage structure 4 where T-shaped and F-shaped nails are placed. Therefore, the frequency of replacing the nail storage structure 4 can be reduced. On the other hand, the nail feeding mechanism 3 can effectively push the T-shaped, F-shaped, and U-shaped nails into the nailing guide structure 2 to accomplish the nailing operations, so that the universality of the present disclosure is improved.

The fastening structure 35 further includes a pulling member 354, the pulling member 354 is fixedly connected to one end of a rotating shaft 355, and the other end of the rotating shaft 355 passing through the nail conveying plate 31 to extend toward the brake 36 is fixedly connected to a turning member 356. In the embodiment, when the pulling member 354 is manually pulled to rotate toward the nail storage structure 4, in this case, the turning member 356 fixedly connected to the other end of the rotating shaft 355 also rotates toward the direction of the nailing guide structure 2. The turning member 356 pushes the shifting rod 351 to move in the rotating process, and together with the shifting rod 351, also pushes the moving member I 322 and the moving member II 332 to move to promote the pushing member 321 and the non-return member 331 to loosen compressing of the coil nails. The above linked structure skillfully resolves the problem of manually loading the nails rapidly.

Specific embodiments described herein are merely illustrations of the spirit of the present disclosure. Those skilled in the art can make various modifications or replenishments on the described specific embodiments or replace them with similar modes, and these modifications or replenishments will not depart from the spirit of the present disclosure or surpass the range defined by the appended claims.

What is claimed is:

1. A coil nailer, comprising:
a nailing guide structure fixedly connected to a nailer body and configured for guiding nailing,
a nail storage structure configured for storing coil nails, and
a nail feeding mechanism fixedly connected between the nailing guide structure and the nail storage structure;
wherein the nail feeding mechanism comprises a nail conveying plate configured for guiding the coil nails and limiting a moving direction of the coil nails, a side of the nail conveying plate is provided with a pushing structure for pushing the coil nails to the nailing guide structure, and two sides of the pushing structure in a same direction are separately provided with a non-return assembly for preventing the coil nails from moving back to the nail storage structure;
a fastening structure configured for pressing an end of the nail storage structure is provided above the nail feeding mechanism, and the fastening structure is further provided with a shifting rod configured for shifting the pushing structure and the non-return assemblies away from the coil nails;
the pushing structure comprises a pushing member and a first moving member enclosing the pushing member, and at least two pushing members are provided; a first groove is formed below the first moving member, the first groove is in sliding fit with a first boss with a slope in a linking member, wherein the linking member semi-encloses the pushing member and the first moving member; perpendicular to the nail conveying plate, an end of the linking member passes through a brake for connection, and the brake drives the pushing structure to reciprocate; and
the non-return assembly comprises a non-return member and a second moving member enclosing the non-return member, and a second groove is formed below the second moving member; below the corresponding second moving member, a second boss in sliding fit with the second groove is further provided on the nail conveying plate, and an inclined slope is provided between the second boss and a horizontal plane.

2. (canceled)

3. (canceled)

4. The coil nailer according to claim 1, wherein perpendicular to the moving direction of the coil nails, waist-shaped holes are respectively formed on both sides of the first moving member and the second moving member, and a first protruding portion is provided on a side of each of the first moving member and the second moving member toward the shifting rod.

5. The coil nailer according to claim 1, wherein a cover plate configured for being opened or closed is provided above the nail conveying plate, a first end of the cover plate is hinged with the nailing guide structure, and a second end of the cover plate extends toward the nail storage structure; and in the moving direction of the coil nails, a plurality of notches for avoiding nail caps are further provided on two planes where the nail conveying plate and the cover plate attach each other, and the plurality of notches are provided in an equally divided manner.

6. The coil nailer according to claim 5, wherein in a direction adjacent to the nail storage structure, a second protruding portion is provided at the second end of the cover plate, and a positioning portion is further provided relative to the second protruding portion; the fastening structure comprises a fastening member, and the fastening member slides in the positioning portion; perpendicular to an upper side of the cover plate, the second protruding portion is in threaded fit with a screw, and an elastic member is sleeved on the screw and is provided between the second protruding portion and the fastening member; and the fastening member is further provided with an extension portion extending toward the shifting rod, and a floating member in sliding fit with the nail conveying plate is further provided below the fastening member.

7. The coil nailer according to claim 1, wherein a guide bar parallel to the nail conveying plate is further provided between the nailing guide structure and the nail storage structure.

8. The coil nailer according to claim 1, wherein the nail conveying plate is further provided with a nail limiting groove configured for sleeving a U-shaped nail on the nail conveying plate to move.

9. The coil nailer according to claim 8, wherein the fastening structure further comprises a pulling member, wherein the pulling member is fixedly connected to a first end of a rotating shaft, and a second end of the rotating shaft passing through the nail conveying plate to extend toward the brake is fixedly connected to a turning member.

10. The coil nailer according to claim 1, wherein a signal rod extending toward the coil nails is provided between the pushing structure and the brake.

11. The coil nailer according to claim 9, wherein a signal rod extending toward the coil nails is provided between the pushing structure and the brake.
